(19) United States
(12) Patent Application Publication
(10) Pub. No.: US 2020/0002594 A1
(43) Pub. Date: Jan. 2, 2020

(54) COMPOSITIONS FOR USE IN DRILLING FLUIDS

(71) Applicant: Prince Energy LLC, Houston, TX (US)

(72) Inventors: Carl Randall Ray, Houston, TX (US); Dustin J. Richard, Humble, TX (US)

(73) Assignee: Prince Energy LLC, Houston, TX (US)

(21) Appl. No.: 16/465,463

(22) PCT Filed: Nov. 30, 2016
(86) PCT No.: PCT/US2016/064170

§ 371 Date: May 30, 2019

(51) Int. Cl. C09K 8/36; C09K 8/528; E21B 37/06

(52) U.S. Cl. CPC C09K 8/36; E21B 37/06; C09K 8/528

(57) ABSTRACT

The present disclosure provides a composition for use in drilling fluids comprising an adsorbing substrate that is loaded with a hydrophobic liquid. In one aspect, the hydrophobic liquid comprises a base oil, an emulsifier, a rheology modifier, a viscosifier, a quaternary amine or a mixture thereof. The composition may be combined with an oil-based or hydrocarbon continuous phase, and an aqueous dispersed phase to form a non-aqueous phase invert emulsion for use in drilling applications.

Not Applicable.

### STATEMENT REGARDING FEDERALLY SPONSORED RESEARCH OR DEVELOPMENT

Not Applicable.

### FIELD OF THE INVENTION

The present disclosure is directed to a composition for use in drilling fluids. In general, the composition includes an adsorbing substrate that has been loaded with a hydrophobic liquid generally used in drilling fluids, including, but not limited to, a base oil, an emulsifier, a rheology modifier, a viscosifier, a quaternary amine or a mixture thereof. In one particular embodiment, the composition includes an adsorbing substrate that has been loaded with a hydrophobic liquid comprising a tall oil fatty acid, an imidazoline, a polyamide, a carboxylic acid fatty amine condensate or a mixture thereof. The composition may be combined with an oil-based or hydrocarbon continuous phase, and an aqueous dispersed phase to form a non-aqueous phase invert emulsion for use in drilling applications.

### BACKGROUND OF THE INVENTION

Drilling fluid circulating systems employed during downhole drilling operations provide a number of functions. Such functions can include: providing cooling to a drill bit during drilling operations; carrying drilled cuttings to the surface; and, providing a hydrostatic head to the formation to prevent the escape of oil and gas from the well. In addition, the drilling fluid further provides a medium in which information relating to the wellbore can be obtained through the examination of drilled cuttings, drilled core samples and drilling measurements from downhole tools and wireline logs. In conjunction with the above functions, the drilling fluid must also not harm personnel, the environment, or interfere with the normal production of the well. Finally, the drilling fluid must not cause excessive wear or corrosion to any mechanical components that it may come in contact during operations.

There are two general classes of drilling fluids, namely water-based and oil-based drilling fluids. Water-based drilling fluids are less expensive than oil-based drilling fluids, but are sometimes not effective in all formations. For example, water-based systems can cause operational problems in formations such as hydratable shales, silts or clays. Within these formations, there is a tendency for the hydratable materials to destabilize the wellbore and disperse within the drilling fluid. This dispersion causes a substantial increase in the solids content of the drilling fluid leading to various problems, including solids separation difficulties at the surface and detrimental increases to the fluid's viscosity.

In order to overcome the difficulties associated with water-based drilling fluids, drilling fluids comprised of oil are often used. Such fluids, often referred to as non-aqueous phase (NAF) invert emulsions, employ a non-aqueous continuous phase (for e.g., diesel, mineral oil, or various synthetic fluids) and an aqueous internal phase (for e.g., CaCl₂) brine) dispersed within the continuous NAF phase as very fine droplets.

NAF invert emulsions offer several key performance advantages over water-based systems including greater thermal stability, lubricity, and contamination resistance. They can therefore be used in more demanding environments, such as in high angle, extended reach wells most commonly encountered today. The low maintenance costs of NAF invert emulsion fluids, their ability to be recycled for repeated well applications and their performance advantages make these fluids a more favored drilling fluid for shale production drilling which is the common type of drilling performed in the United States today.

NAF invert emulsions may be prepared by blending a hydrocarbon oil with brine under high shear conditions in the presence of a water-in-oil emulsifier. Emulsification is complete when the aqueous phase is completely emulsified into the NAF continuous phase such that is there is no phase separation of the two fluids. The emulsifier is required to form a stable dispersion of non-aqueous droplets in the NAF continuous phase. Emulsifiers and oil wetting agents also “oil-wet” any solids in the fluid, such as drilled solids and solids added for density (for e.g. barite). This function of the emulsifiers and wetting agents is critically important as drilled solids and barite are preferentially “water-wet” solids and must be converted to oil-wet solids to maintain a stable NAF invert emulsion fluid.

Other solids that may be incorporated into invert emulsion systems, besides weighting materials and drilled solids, include organoclays and lime which are used to increase the effectiveness of emulsifiers and prevent contamination from CO₂. Other additives might also include materials that affect fluid viscosity, fluid density, fluid filtration, and thermal stability.

The emulsifiers and additives used in invert emulsions are generally provided and used as liquid formulations. However, these liquid formulations are usually very viscous and must be diluted with solvent prior to transport and use in a well. Not only can the particular solvent that is used present health, safety, environmental (HSE) and/or performance issues, certain additives, such as pour point depressants, may also present HSE and performance issues when present as a liquid formulation.

Thus, there has been a recent trend to provide emulsifiers and other additives in a dry solid state. For example:

WO 2016/090205 describes the use of silica having a carrying capacity of between 40-75 volume per mass percent as a dry carrier for certain well bore additives, such as wetting agents, thinners and rheology modifiers;

U.S. Pat. App. Publ. No. 2016/0152797 discloses emulsifier particles obtained by the mechanical attrition of an emulsifier solid and their use in drilling fluids;

U.S. Pat. App. Publ. No. 2016/0009980 describes shaped compressed pellets comprising a binder and a water-insoluble adsorbent having an additive, such as a demulsifier, a scale inhibitor, surfactant or dispersant, adsorbed thereon which can be used in the treatment of production wells;

U.S. Pat. No. 8,927,468 teaches a method for producing a spray dried emulsifier which can be subsequently used in drilling fluids;

U.S. Pat. Nos. 7,493,955 and 7,491,682 disclose water-insoluble adsorbents containing a scale inhibitor and their use for preventing and/or controlling the formation of inorganic scales in a production well; and

U.S. Pat. No. 6,905,698 which describes a porous inorganic carrier having a biocide incorporated therein and its use in drilling mud.

In spite of these state of the art dry systems, there is a continuing need to develop new and more environmentally acceptable and cost effective systems that are capable of being used in connection with production wells.

### SUMMARY OF THE INVENTION

The present disclosure provides a composition for use in drilling fluids comprising an adsorbing substrate that has been loaded with a hydrophobic liquid generally used in drilling fluids, including, but not limited to, a base oil, an emulsifier, a rheology modifier, a viscosifier, a quaternary amine or a mixture thereof. In one particular aspect, the composition includes an adsorbing substrate that has been loaded with a hydrophobic liquid comprising a tall oil fatty acid, an imidazoline, a polyamide, a carboxylic acid fatty amine condensate or a mixture thereof.

According to another aspect, there is provided a method for producing the composition above by contacting the adsorbing substrate with the hydrophobic liquid.

In still another aspect, there is provided a non-aqueous phase invert emulsion obtained by combining the composition described above with an oil phase and an aqueous phase.

### DETAILED DESCRIPTION OF THE INVENTION

The present disclosure provides a composition for use in a drilling fluid. The composition generally contains an adsorbing substrate that has been loaded with a hydrophobic liquid generally used in drilling fluids, including, but not limited to, a base oil, an emulsifier, a rheology modifier, a viscosifier, a quaternary amine or a mixture thereof. In one particular embodiment, the composition includes an adsorbing substrate that has been loaded with a hydrophobic liquid comprising a tall oil fatty acid, an imidazoline, a polyamide, a carboxylic acid fatty amine condensate or a mixture thereof. The adsorbing substrate of the present disclosure is a particulate and/or porous carrier, which means it has an outer and/or inner surface onto which the liquid can be adsorbed. Furthermore, the adsorbing substrate does not essentially change its morphology during the adsorption of the hydrophobic liquid. In some embodiments, the adsorbing substrate may be loaded with at least 15% by weight of the hydrophobic liquid or up to about 70% by weight of the hydrophobic liquid, based on the total weight of the adsorbing substrate.

It has been surprisingly found that the liquid-loaded adsorbing substrate of the present disclosure, despite such a high liquid loading, exhibits the handling characteristics of a dry flowable powder. By “handling characteristics of a dry powder” it is meant that the liquid-loaded adsorbing substrate has the ability to be handled like a bulk solid powder, without significant clumping or pasting. Thus, the present disclosure yields compositions comprising an adsorbing substrate highly loaded with a hydrophobic liquid wherein the flowability characteristics of the composition will be substantially similar to the flowability characteristics of a composition comprising the same adsorbing substrate in non-liquid-loaded form. The liquid-loaded adsorbing substrate of the present disclosure is distinguished from state of the art dry systems, such as those described above, since a spray drying process is omitted during its preparation simplifying the overall process and reducing cost. Furthermore, because the hydrophobic liquids are in a dry solid state, they can be packaged in sacks and containers as dry materials are therefore easily handled alleviating transportation issues that can arise when transporting liquids or when using in locations not set up for handling liquids due to space and/or equipment limitations. Finally, the liquid-loaded adsorbing substrate will not encounter problems associated with liquid emulsifiers and wetting agents which are temperature dependent and tend to become very viscous and hard to pour when exposed to cold climates.

The following terms shall have the following meanings:

As used herein, the term “loading” refers to the process of applying to the surface of the adsorbing substrate an amount of liquid such that in a final composition of liquid-loaded adsorbing substrate, the weight of the liquid that has been loaded will comprise a significant percent of the total weight of the final composition.

The term “liquid” is used herein as that term is used commonly in the scientific art when referring to the “liquid” state of matter (versus a gas or a solid), and includes both aqueous and non-aqueous liquids.

The term “hydrophobic liquid, as used herein, is defined as a liquid which is not miscible with water.

The term “liquid loading” and “liquid-loaded” as used in this disclosure describes the process of applying a substance in its liquid form to the adsorbing substrate or a liquid that has been applied to the adsorbing substrate. The substance may be one that is liquid at room temperature, or alternatively, it may be one that is heated above its melting temperature upon delivery into the loading apparatus, such that it is in liquid or molten form during the loading process, but will then solidify subsequent to the loading process when the ambient temperature of the adsorbing substrate falls below the melting temperature of the substance that has been loaded. In either case, even when the liquid loading material remains in liquid form after the loading process, the composition of loaded adsorbing substrate will retain the characteristics of a dry flowable powder.

The term “drilling fluid” means a fluid for use in conjunction with drilling operations or the completing or working over a subterranean well.

The term “emulsifier” refers to a component that creates an emulsion, a dispersion of one immiscible liquid into another, by reducing the interfacial tension between the two liquids to achieve stability.

The term “rheology modifier” refers to a component that provides significant thickening effect in a liquid at relatively low concentrations.

The term “viscosifier” refers to a component that alters a liquid's viscosity.

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article. By way of example, “a liquid” means one liquid or more than one liquid.

The phrases “in one embodiment”, “according to one embodiment” and the like generally mean the particular feature, structure, or characteristic following the phrase is included in at least one embodiment of the present disclosure, and may be included in more than one embodiment of the present disclosure. Importantly, such phrases do not necessarily refer to the same aspect.

If the specification states a component or feature “may”, “can”, “could”, or “might” be included or have a characteristic, that particular component or feature is not required to be included or have the characteristic.

According to one aspect, the present disclosure provides a composition for use in drilling fluids comprising a liquid-loaded adsorbing substrate where the liquid is a hydrophobic liquid. The hydrophobic liquid may be any hydrophobic liquid useful in drilling fluids. For instance, the hydrophobic liquid may be a base oil, an emulsifier, a rheology modifier, a viscosifier, a quaternary amine or a mixture thereof. Examples of such hydrophobic liquids may include, without limitation, diesel oils, paraffin oils, mineral oils, low toxicity mineral oils, synthetic oils such as polyolefins, hydrocarbons, dimers, trimers or tetramers of fatty acid originating from known fatty acids, such as C₁₂-C₂₂ fatty acids, reaction products of polyamines and polycarboxylic acids, condensation products of a dimer or trimer fatty acid and diethanolamine, synthetic polymers such as polyacrylamides, acrylic polymer emulsions, tetra alkyl ammonium (for e.g. tetramethylammonium chloride, tetraethylammonium chloride), bis-(hydrogenated tallow)-dimethyl-ammonium chloride, bis-(hydrogenated tallow)-benzyl-methyl-ammonium chloride, dicoco ammonium chloride, trimethyl-n-propylammonium chloride and triethyl-n-propylammonium nitrate and mixtures thereof.

In one particular aspect, the hydrophobic liquid comprises a tall oil fatty acid, an imidazoline, a polyamide, a carboxylic acid fatty amine condensate or a mixture thereof.

According to one aspect, the adsorbing substrate may have a high surface area. In some embodiments, the adsorbing substrate has a surface area of greater than 100 m²/g (for e.g., greater than 200 m²/g, or greater than 300 m²/g, or greater than 400 m²/g, or greater than 500 m²/g, or greater than 750 m²/g, or greater than 1000 m²/g, or greater than 1250 m²/g, or greater than 1500 m²/g, or greater than 1750 m²/g, or greater than 1900 m²/g). In other embodiments, the adsorbing substrate has a surface area of 2000 m²/g or less (for e.g., 1900 m²/g or less, or 1850 m²/g or less, or 1800 m²/g or less, or 1750 m²/g or less, or 1700 m²/g or less, or 1650 m²/g or less, or 1600 m²/g or less, or 1500 m²/g or less, or 1250 m²/g or less, or 1000 m²/g or less, or 800 m²/g or less, or 700 m²/g or less, or 650 m²/g or less, or 600 m²/g or less, or 550 m²/g or less).

The adsorbing substrate can have a surface area ranging from any of the minimum values described above to any of the maximum values described above. For example, the adsorbing substrate can have a surface area ranging from 500 m²/g to 2000 m²/g (for e.g., from 750 m²/g to 2000 m²/g, or from 1000 m²/g to 2000 m²/g, or from 1000 m²/g to 1750 m²/g, or from 1000 m²/g to 1500 m²/g).

In other aspects, the adsorbing substrate can have varying porosity. For instance, the adsorbing substrate can include micropores (pores having a diameter <2 nm), mesopores (pores having a diameter of from 2 to 50 nm), macropores (pores having a diameter of >50 nm), or combinations thereof. The porosity of the adsorbing substrate can be characterized in terms of volume of micropores, mesopores, macropores, or combinations thereof present in the material.

In some embodiments, the adsorbing substrate comprises at least 0.05 mL/g of micropores (for e.g., at least 0.1 mL/g, at least 0.15 mL/g, at least 0.2 mL/g, at least 0.25 mL/g, at least 0.3 mL/g, or at least 0.35 mL/g). In other embodiments, the adsorbing substrate comprises 0.4 mL/g of micropores or less (for e.g., 0.35 mL/g or less, 0.3 mL/g or less, 0.25 mL/g or less, 0.2 mL/g or less, 0.15 mL/g or less, or 0.1 mL/g or less). The adsorbing substrate can comprise a volume of micropores ranging from any of the minimum values above to any of the maximum values described above. For example, the adsorbing substrate can comprise a volume of micropores ranging from 0.05 mL/g to 0.4 mL/g (for e.g., from 0.1 mL/g to 0.3 mL/g).

In still other embodiments, the adsorbing substrate comprises at least 0.1 mL/g of mesopores (for e.g., at least 0.15 mL/g, at least 0.2 mL/g, at least 0.25 mL/g, at least 0.3 mL/g, at least 0.35 mL/g, at least 0.4 mL/g, at least 0.45 mL/g, at least 0.5 mL/g, at least 0.55 mL/g, at least 0.6 mL/g, at least 0.65 mL/g, at least 0.7 mL/g, at least 0.75 mL/g, at least 0.8 mL/g, at least 0.85 mL/g, at least 0.9 mL/g, at least 0.95 mL/g, at least 1.0 mL/g, at least 1.05 mL/g, at least 1.10 mL/g, at least 1.15 mL/g, or at least 1.20 mL/g). In other embodiments, the adsorbing substrate comprises 1.25 mL/g of mesopores or less (for e.g., 1.20 mL/g or less, 1.15 mL/g or less, 1.10 mL/g or less, 1.05 mL/g or less, 1.0 mL/g or less, 0.95 mL/g or less, 0.9 mL/g or less, 0.85 mL/g or less, 0.8 mL/g or less, 0.75 mL/g or less, 0.7 mL/g or less, 0.65 mL/g or less, 0.6 mL/g or less, 0.55 mL/g or less, 0.5 mL/g or less, 0.45 mL/g or less, 0.4 mL/g or less, 0.35 mL/g or less, 0.3 mL/g or less, 0.25 mL/g or less, 0.2 mL/g or less, or 0.15 mL/g or less). The adsorbing substrate can comprise a volume of mesopores ranging from any of the minimum values above to any of the maximum values described above. For example, the adsorbing substrate can comprise a volume of mesopores ranging from 0.1 mL/g to 1.25 mL/g (for e.g., 0.2 mL/g to 1.25 mL/g, 0.75 mL/g to 1.25 mL/g, from 0.1 mL/g to 1.0 mL/g, or from 0.2 mL/g to 0.9 mL/g).

According to other embodiments, the adsorbing substrate comprises at least 0.1 mL/g of macropores (for e.g., at least 0.15 mL/g, at least 0.2 mL/g, at least 0.25 mL/g, at least 0.3 mL/g, at least 0.35 mL/g, at least 0.4 mL/g, at least 0.45 mL/g, at least 0.5 mL/g, at least 0.55 mL/g, at least 0.6 mL/g, or at least 0.65 mL/g). According to other embodiments, the adsorbing substrate comprises 0.7 mL/g of macropores or less (for e.g., 0.65 mL/g or less, 0.6 mL/g or less, 0.55 mL/g or less, 0.5 mL/g or less, 0.45 mL/g or less, 0.4 mL/g or less, 0.35 mL/g or less, 0.3 mL/g or less, 0.25 mL/g or less, 0.2 mL/g or less, or 0.15 mL/g or less). The adsorbing substrate can comprise a volume of macropores ranging from any of the minimum values above to any of the maximum values described above. For example, the adsorbing substrate can comprise a volume of macropores ranging from 0.1 mL/g to 0.7 mL/g (for e.g., from 0.2 mL/g to 0.6 mL/g, or from 0.25 mL/g to 0.55 mL/g).

In some embodiments, the adsorbing substrate comprises a greater volume of micropores than volume of mesopores or volume of macropores. In other embodiments, the adsorbing substrate comprises a greater volume of mesopores than volume of micropores or volume of macropores. In still further embodiments, the adsorbing substrate comprises a greater volume of macropores than volume of micropores or volume of mesopores.

In some cases, the ratio of the volume of micropores in the adsorbing substrate to the volume of mesopores in the adsorbing substrate may range from 1:7.5 to 2:1. For example, the ratio of the volume of micropores in the adsorbing substrate to the volume of mesopores in the adsorbing substrate can be 3:5, 1:3.6, 1:2, or 1.5:1. In other cases, the ratio of the volume of mesopores in the adsorbing substrate to the volume of macropores in the adsorbing substrate may range from 1:2 to 1:0.25. For example, the ratio of the volume of mesopores in the adsorbing substrate to the volume of macropores in the adsorbing substrate can be 1:1.25, 1:0.6, or 1:1. In further cases, the ratio of the volume of micropores in the adsorbing substrate to the volume of macropores in the adsorbing substrate may range from 1:5 to 1:0.7. For example, the ratio of the volume of micropores in the adsorbing substrate to the volume of mesopores in the adsorbing substrate can be 1:3, 1:2.2, 1:2, or 1:0.83.

According to another aspect, the adsorbing substrate comprises an inorganic adsorbing substrate, an organic adsorbing substrate or a mixture thereof.

The inorganic adsorbing substrate may be a silicate, an aluminosilicate, perlite, diatomaceous earth, a metal oxide, a metal hydroxide, or a mixture thereof.

Examples of silicates include, but are not limited to, silica (for e.g., quartz) and feldspar (for e.g., albite and plagioclase). Other silicates include chlorite, clay mineral, such as nontronite, mica and talc. In one particular embodiment, the silicate is a metal silicate selected from the group of magnesium silicates and calcium silicates. In one embodiment, the magnesium silicate includes talc and the calcium silicate includes wollastonite.

Aluminosilicates are known to those skilled in the art and may comprise, for example, acid-activated bentonites (bleaching earths) and zeolites. Acid-activated bentonites (bleaching earths) are bentonites, the smectites of which (swellable or clay minerals) have been partially dissolved by acid treatment and thus have a high surface area and a large micropore volume. Bentonites are clays which have been formed by the weathering of volcanic ash (tufa) and consist of the minerals montmorillonite and beidellite (the smectite mineral group).

In one particular embodiment, the aluminosilicate includes zeolites, and in this context, zeolites which do not contain aluminum can also come under this disclosure. Zeolites are a widely distributed group of crystalline silicates, more precisely of water-containing alkali metal or alkaline earth metal aluminosilicates of the general formula M_{2/z}O.Al₂O₃.x SiO₂.y H₂O, where M=monovalent or polyvalent metal (usually an alkali metal or an alkaline earth metal cation), H or NH₄, z=the valency of the cation, x=from about 1.8 to about 12 and y=from 0 to about 8.

Zeolites according to the present disclosure relate not only to natural zeolites but also to synthetic zeolites. The naturally occurring zeolites are formed by hydrothermal conversion from volcanic glasses or tufa-containing deposits. According to their crystal lattices, the natural zeolites may be classified into fibrous zeolites (for e.g., mordenite, MOR), leaf zeolites and the cubic zeolites (for e.g., faujasite, FAU, and offretite, OFF). The differing zeolites are usually given three-letter codes (for example MOR, FAU, OFF).

To prepare synthetic zeolites, the starting materials used are SiO₂-containing (for e.g., waterglasses, silica fillers, silica sols) and Al₂O₃-containing (for e.g., aluminum hydroxides, aluminates, kaolins) substances which, together with alkali metal hydroxides (usually NaOH) are converted to the crystalline zeolites at temperatures above 50° C. in the aqueous phase.

The inorganic adsorbing substrate may also be perlite. Perlite is the petrographic term for a siliceous volcanic rock which naturally occurs in certain regions throughout the world. The distinguishing feature, which sets it apart from other volcanic minerals, is its ability to expand four to twenty times its original volume when heated to certain temperatures. When heated above 870° C., crushed perlite expands due to the presence of combined water with the crude perlite rock. The combined water vaporizes during the heating process and creates countless tiny bubbles in the heat softened glassy particles. It is these diminutive glass sealed bubbles which account for its light weight. Expanded perlite can be manufactured to weigh as little as 2.5 lbs. per cubic foot. Typical chemical analysis properties of expanded perlite are: silicon dioxide 73%, aluminum oxide 17%, potassium oxide 5%, sodium oxide 3%, calcium oxide 1%, plus trace elements. Typical physical properties of expanded perlite are: softening point 870-1090° C., fusion point 1260-1340° C., pH 6.6-6.8, and specific gravity 2.2-2.4. The term “expanded perlite” as used herein refers to the spherical form of perlite which has been expanded by heating the perlite siliceous volcanic rock to a temperature above 870° C. In some embodiments, the perlite may be milled perlite which denotes that form of expanded perlite which has been subjected to crushing so as to form a particulate mass wherein the particle size of such mass is comprised of at least 97% of particles having a size of less than 2 microns.

In yet another embodiment, the inorganic adsorbing substrate is diatomaceous earth. Diatomaceous earth is a naturally occurring substance comprising the microscopic outer shell of a diatom. The principal constituent of diatomaceous earth is SiO₂ with minor amounts of other components, depending upon the source of the naturally occurring deposit. The diatomaceous earth may be a natural grade diatomaceous earth, calcined diatomaceous earth or flux-calcined diatomaceous earth. Natural grade diatomaceous earth is mined, crushed, dried and air classified to provide a uniform particle size which is extremely fine. The calcined grade of diatomaceous earth is similar to the natural grade, but is subjected to calcining at elevated temperatures, generally about 980° C. Finally, flux-calcined diatomaceous earth is generally produced by the addition of a fluxing agent to a natural grade diatomaceous earth prior to calcination. The fluxing agent can be soda ash, potash, or any known material which acts as a flux.

In some embodiments, minor amounts of water insoluble modifiers may be mixed with the diatomaceous earth. Examples of such modifiers include volcanic ash, petalite, perlite, fly ash, wash ash, sand, silica dust, clays, refractory slags, gypsum, talc, glass powders, refractory fibrous materials, and other naturally occurring minerals and oxides. Other modifiers can be water insoluble compounds of Fe, Cu, Ni, Mg, Al, Ca, Ba, and Sr. Modifiers may be substituted for diatomaceous earth in amounts up to about 25 weight percent of the dry impregnated diatomaceous earth. In the case of volcanic ash and fly ash, amounts up to about 50 weight percent may be substituted.

The inorganic adsorbing substrate may also be a metal oxide or metal hydroxide. Examples include, but are not limited to, oxides or hydroxides of titanium, zirconium, cerium, manganese, zinc, iron, calcium and magnesium such as titania, zirconia, ceria, manganese oxide, zinc oxide, iron oxides, calcium oxide, manganese dioxide, or combinations thereof.

In another aspect, the adsorbing substrate is an organic adsorbing substrate. In some embodiments, the organic adsorbing substrate is a fibrous cellulose component, an asphalt-based hydrocarbon, carbon black, activated carbon or a mixture thereof.

The fibrous cellulose component may be natural or chemically modified. In one embodiment, the fibrous cellulose component is natural and preferably a plant fiber, such as a wood fiber, that is defined as having a length at least three times its diameter. The fibrous cellulose component may include, for example, wood fibers, fiber pile, chip wash solids, fiber waste, wood fiber fines, etc. The fibrous cellulose component may comprise any fibrous cellulose material and may be obtained as a by-product of paper-making or other wood processing operations. One source may be a wash of wood or cellulose items as a prelude to being processed. In addition, the fibrous cellulose component may be produced in other ways or obtained from other sources, and may be formed of other plant or cellulose materials, such as a cotton fiber or a cotton lint.

Chemically modified cellulose fibers may include cellulosic materials which have been transformed by derivatization in such a way as to induce a significant increase in their hydrophilic character. Examples of derivatization processes may include carboxylation, phosphorylation, and grafting of acrylic segments.

According to another embodiment, the organic adsorbing substrate is an asphalt-type hydrocarbon. The term “asphalt” (i.e., bitumen) is used in its conventional sense to refer to the natural or manufactured black or dark-colored solid material composed mainly of high molecular weight hydrocarbons derived from a cut in petroleum distillation after naphtha, gasoline, kerosene and other fractions have been removed from crude oil. Asphalt products may be composed of saturated and unsaturated aliphatic and aromatic compounds that possess functional groups that include, but are not limited to alcohol, carboxyl, phenolic, amino, thiol functional groups. The molecular weight of asphalt products may range from 0.2 kDa to 50 kDa, such as 1 kDa to 25 kDa, including 2 kDa to 10 kDa. Components of asphalts may be asphaltenes (i.e., high molecular weight compounds that are insoluble in hexane or heptane) or maltenes (i.e., lower molecular weight compounds that are soluble in hexane or heptane).

The organic adsorbing substrate may also be carbon black. In general, carbon black is manufactured from liquid or gaseous hydrocarbons by partial or incomplete combustion processes involving flames, examples of which include lamp blacks, channel blacks and furnace blacks, or by thermal decomposition processes in the absence of air or flames.

Most carbon blacks produced via partial combustion processes contain significant amounts of chemically combined surface oxygen and oxygen compounds, in addition to varying amounts of moisture, sulfur and inorganic salts.

Any of the various grades and industry types of thermal and acetylene carbon blacks from thermal decomposition processes are suitable for use herein. These include carbon blacks identified by ASTM classifications N880 FT-FF (fine thermal black, free flowing), N881 FT (fine thermal black), N990 MT-FF (medium thermal black, free flowing), N907 MT-NS-FF (medium thermal black, nonstaining, free flowing), N908 MT-NS (medium thermal black, nonstaining) and N991 MT (medium thermal black).

The organic adsorbing substrate may also be activated carbon. Suitable activated carbons may be produced from various carbonaceous raw-materials using methods known in the art, each of which impart particular qualities to the resultant activated carbon. For example, activated carbons can be prepared from lignite, coal, bones, wood, peat, paper mill waste (lignin), and other carbonaceous materials such as nutshells. Activated carbons can be formed from carbonaceous raw materials using a variety of methods known in the art, including physical activation (for e.g., carbonization of the carbonaceous raw material followed by oxidation) and chemical activation.

A variety of forms of activated carbon can be used, including powdered activated carbon (PAC; a particulate form of activated carbon containing powders or fine granules of activated carbon), granular activated carbon (GAC), extruded activated carbon (EAC); powdered activated carbon fused with a binder and extruded into a variety of shapes), bead activated carbon (BAG), and activated carbon fibers. Suitable forms of activated carbon can be selected in view of their desired level of catalytic activity as well as process considerations (for e.g., ease of separation). Suitable activated carbons include wood FACs, such as NOR IT® CA L NORIT® CA3, DARCO® KB-G, and DARCO® KB-M; wood GACs, such as NORIT® C GRAN; coal PACs, such as NORIT® PAC 200; coal GACs, such as NORIT® GAC 300; and steam activated PACs derived from other carbon sources, such as DARCO® G-60, all of which are commercially available from Cabot Norit Americas, Inc.

In some embodiments, the activated carbon comprises granular activated carbon (GAC). The GAC can have a particle size ranging from 4 mesh to 325 mesh, based on United States Standard Sieve Series.

According to one particular aspect, the hydrophobic liquid that is loaded onto the adsorbing substrate is a tall oil fatty acid. The tall oil fatty acid (TOFA) may be obtained by the distillation of crude tall oil. Crude tall oil, a by-product of the Kraft pulping process, is a mixture of fatty acids, rosin acids and unsaponifiables. These components can be separated from one another by a series of distillations. The fatty acids are predominantly 18-carbon straight-chain mono- or di-unsaturated fatty acids. Specifically, the fatty acids may include oleic acid, 9,12-linoleic acid, 9,11-linoleic acid (conjugated linoleic acid), stearic acid, pinolenic acid, eicosenoic acid, palmitic acid, palmitoleic acid, magaric acid, octadecadienoic acid, octadecatrienoic acid and the like. Generally speaking, the tall oil fatty acids for use in the present disclosure may contain from about 28% to about 55% by weight of oleic acid, from 25% to 40% by weight of linoleic acid, and from 4% to 20% by weight of the conjugated linoleic acid, based on the total weight of the tall oil fatty acid. The remaining fatty acid components may comprise from 1% to 15% by weight of any of the remaining above mentioned fatty acids, for example, from 1% to 4% by weight of stearic acid. In addition to the fatty acids, the tall oil fatty acids may also contain minor amounts of rosin acids, for example in an amount not to exceed 8% by weight, based on the total weight of tall oil fatty acids. Rosin acids that are generally found in tall oil fatty acid mixtures may include abietic acid, dihydroabietic acid, palustric/levopimaric acid, 9,10-secodehydroabietic acid, pimaric acids, tetrahydroabietic acid, isopimaric acid, neoabietic acid, and the like. In one particular embodiment, the range of component acids in the tall oil fatty acid can comprise from 41% to 47% by weight of oleic acid, from 30% to 40% by 9,12 linoleic acid, from 10% to 19% 9,11 (conjugated) linoleic acid, and from 0 to 6% by weight rosin acids, based on the total weight of the tall oil fatty acids. The respective weight percentages of the fatty acids may be determined according to ASTM D-803-65. The respective weight percentages of the rosin acids may be determined by ASTM D-1240-54.

The tall oil fatty acid may also be a modified or oxidized tall oil fatty acid. Modified tall oil fatty acids are described in U.S. Pat. No. 8,927,468 and U.S. Pat. Publ. No. 20090065736, the contents of which are incorporated herein by reference. Modified tall oil may be produced by reaction of tall oil with an unsaturated polycarboxylic acid and/or an unsaturated carboxylic acid anhydride. The unsaturated polycarboxylic acids include C₄-C₁₀ unsaturated dicarboxylic acids, such as maleic acid and fumaric acid. Examples of the unsaturated carboxylic acid anhydride includes maleic anhydride. The modified tall oil may be further modified and such modifications may include those selected from the group consisting of (1) esterification with ricinoleic acid, (2) amidation using a polyamine supplied in an amount sufficient to cause cross linking between modified tall oil molecules, (3) a combination of esterification and amidation using an amino alcohol supplied in an amount sufficient to cause cross linking between modified tall oil molecules, (4) esterification with an alkynyl alcohol (acetylenic alcohol) selected from propargyl alcohol, 1-hexyn-3-ol, 5-decyne-4,7-diol, oxyalkylated propargyl alcohol and mixtures thereof, (5) amidation with morpholine, (6) amidation with a fatty imidazoline, (7) esterification with a phosphate ester, (8) reaction with a metal chelator (metal chelator modification), (9) reaction with an amino acid, (10) xanthate modification, (11) thiophosphate ester modification, (12) hydroxamic acid modification, (13) sulfonate modification, (14) sulfate modification and combinations thereof.

In addition, the above tall oil fatty acid may further be oxidized as described in U.S. Pat. No. 8,133,970, the contents of which are incorporated herein by reference. In these compounds, at least two backbone structures of the tall oil fatty acid are linked to one other by a bridging group chosen from a direct bond, an ether linkage, or a peroxide linkage located at a non-terminal position of each backbone structure generally yielding dimerized tall oil fatty acids and even higher molecular weight products. Mixtures of the above tall oil, modified tall oil and/or oxidized tall oil may also be used.

In another embodiment, the hydrophobic liquid loaded onto the adsorbing substrate is an imidazoline. The imidazoline may by prepared from the reaction of a polyamine with a fatty acid at high temperature (for e.g., 175° C.) with water extraction to permit ring closure thereby producing the imidazoline. The fatty acid may be generally represented by the formula RCOOH where R is a C₆ to C₃₀ alkyl group, such as an alkyl group having from about 10 to 25 carbon atoms. Examples of fatty acids used in preparing the imidazoline may include, but are not limited to, lauric acid, myristic acid, palmitic acid, stearic acid, arachidic acid, behenic acid, oleic acid, linoleic acid and erucic acid. Mixtures of fatty acids may also be used.

The polyamine may be represented by the general formula H₂NCH₂CH₂NH(CH₂CH₂NR₁)ₐH where R₁ is hydrogen, C₁-C₁₀ alkyl or (CH₂CH₂NH)_{b} H, a is an integer between 0 and 10 and b is an integer between 0 and 8. In some embodiments, the sum of a and b does not exceed 10. Examples of polyamines may include, but are not limited to, ethylenediamine, diethylenetriamine, tetraethylenepentamine, hexaethyleneheptamine, and polyamines such as those in which internal (secondary) nitrogens bear the (CH₂CH₂NH)_{b}H group.

The imidazoline may also be a modified imidazoline. Modified imidazolines include imidazolines which have been oxidized, sulfonated or sulfitated. Oxidation may accomplished by reacting the imidazoline with an oxidant such as hydrogen peroxide, air, ozone, organic hydroperoxides, or the like, to covert a tertiary amine group to an amine oxide functionality according to well-known methods, such as described in U.S. Pat. No. 3,494,924. Sulfonation may be performed using well-known methods, including reaction with sulfur trioxide, optionally in the presence of an inert solvent. Non-limiting examples of solvents include liquid SO₂, hydrocarbons, and halogenated hydrocarbons. Other sulfonating agents can be used with or without use of a solvent (for e.g., chlorosulfonic acid, fuming sulfuric acid), but sulfur trioxide is generally the most economical. Sulfitation may be accomplished using sulfitating agents including, for example, sodium sulfite, sodium bisulfite or sodium metabisulfite. Optionally, a catalyst or initiator may be used, such as peroxides, iron, or other free-radical initiators.

The polyamides which may be used in the present disclosure may be formed from the reaction of a diamine with a fatty acid ester, fatty acid, or combinations thereof. The reaction generally takes place under heat, typically from about 120° C. to 160° C., in the presence of a catalyst. Equivalent amounts of the reactants are preferably employed.

In one embodiment, the diamine may have the general formula R₄HNYNR₂R₃ where R₂ and R₃ are independently selected from the group consisting of hydrogen or a C₁-C₆ alkyl optionally substituted with one or more hydroxyls or alkoxylated hydroxyls (for e.g. methyl, ethyl, —CH₂CH₂OH, or —CH₂CH₂(OCH₂CH₂)ₙOH wherein n is an integer from 1 to 5), and at least one of R² and R³ is not hydrogen; R₄ is hydrogen or C₁-C₆ alkyl; and Y is C₁-C₆ alkyl.

In one embodiment, the fatty acid ester is a glyceride. In general, the glyceride is an ester of one or more fatty acids with glycerol (1,2,3-propanetriol). If only one position of the glycerol backbone molecule is esterified with a fatty acid, the glyceride is a “monoglyceride”; if two positions are esterified, the glyceride is a “diglyceride”; and if all three positions of the glycerol are esterified with fatty acid the glyceride is a “triglyceride” or “triacylglycerol”.

Thus, in one particular embodiment, the fatty acid ester is a triglyceride, especially one comprising C₆-C₂₆ fatty acids, and more preferably having a chain length of at least 8, 10, 12, 14, 16, 18, 20, 22, or 24 carbons. The exemplary chain length of the fatty acid component of the glyceride can range from about 12 to about 18 carbon atoms, and the fatty acid may be saturated, monounsaturated, or polyunsaturated and optionally substituted with one or more hydroxyl groups. In the case of unsaturated fatty acids, both conjugated and unconjugated systems are contemplated.

Examples of saturated fatty acids include, but are not limited to, C₄ butyric acid (butanoic acid), C₅ valeric acid (pentanoic acid), C₆ caproic acid (hexanoic acid), 2-ethyl hexanoic acid, C₇ enanthic acid (heptanoic acid), C₈ caprylic acid (octanoic acid), iso-octanoic acid, C₉ pelargonic acid (nonanoic acid), C₁₀ capric acid (decanoic acid), C₁₁ hendecanoic acid, C₁₂ lauric acid (dodecanoic acid), C₁₃ tridecanoic acid, isotridecanoic acid, C₁₄ myristic acid (tetradecanoic acid), C₁₆ palmitic acid (hexadecanoic acid), C₁₇ margaric acid (heptadecanoic acid), C₁₈ stearic acid (octadecanoic acid), iso-stearic acid, C₂₀ arachidic acid (eicosanoic acid), C₂₁ heneicosanoic acid, C₂₂ behenic acid (docosanoic acid), C₂₄ lignoceric acid (tetracosanoic acid). As discussed above, such fatty acids may be present in the form of fatty acid esters, free fatty acids, or combinations thereof.

Examples of unsaturated fatty acids include, but are not limited, to myristoleic acid (14:1), palmitoleic acid (16:1), oleic acid (18:1), petroselinic acid (18:1), ricinoleic acid (18:1), linoleic acid (18:2), linolenic acid (18:3), eleosteric acid (18:3), eoleic acid (18:1), gadoleic acid (20:1), arachidonic acid (20:4), eicosapentaenoic (20:5), and erucic acid (22:1). As discussed above, such fatty acids may be present in the form of fatty acid esters, free fatty acids, or combinations thereof.

The glyceride may also be a phospholipid. A phospholipid (also called a “phosphoglyceride” or “phosphatide”) is a special type of glyceride and differs from a triglyceride by having a maximum of two esterified fatty acids, while the third position of the glycerol backbone is esterified to phosphoric acid, becoming a “phosphatidic acid.” In nature, phosphatidic acid is usually associated with an alcohol which contributes a strongly polar head. Two such alcohols commonly found in nature are choline and enthanolamine. A “lecithin” is a phosphatidic acid associated with the aminoalcohol, “choline,” and is also known as “phosphatidylcholine.” Lecithins vary in the content of the fatty acid component and can be sourced from, for example, eggs and soy. Cephalin (phosphatidylethanolamine), phosphatidylserine and phosphatidylinositol are other phosphoglycerides. Such compounds are also “glycerides” as used herein.

The carboxylic acid terminated fatty amine condensate may prepared from the reaction of a fatty acid amine condensate with a polycarboxylic acid or a carboxylic acid anhydride. Suitable fatty acid amine condensates that may be carboxylated (or reacted to provide a carboxylic acid terminated derivative) include those that are synthesized by reacting a polyalkylene polyamine with a fatty acid. The polyalkylene polyamine may include compounds having the formula H₂N[(CH₂)ₓNH]_{y}H, where x and y are each integers from 1 to about 10. Representative polyalkylene polyamines are the polyethylene polyamines, where x in the formula above is 2. Of this class of polyalkylene polyamines, diethylenetriamine (x=2, y=2), triethylenetetramine (x=2, y=3), tetraethylenepentamine (x=2, y=4) and pentaethylenehexamine (x=2, y=5) are often used. Diethylenetriamine, triethylenetetramine, tetraethylenepentamine used individually are especially suitable. Mixtures of these polyalkylene polyamines may also be employed.

Examples of fatty acids that may be used to react with the polyalkylene polyamine include those described above, such as alkanoic and alkenoic fatty acids having from 10 to 24 carbon atoms including lauric acid, myristic acid, palmitic acid, stearic acid, arachidic acid, behenic acid, oleic acid, linoleic acid and erucic acid. Mixtures of fatty acids may also be used.

In some embodiments, the adsorbing substrate may also include asphaltite, while the hydrophobic liquid may also include a long chain cationic surfactant and/or a long chain anionic surfactant. Long chain cationic surfactants include those having at least 12 carbon atoms in at least one alkyl chain, and illustrative examples are fatty dialkyl quaternary amine salts, mono fatty alkyl tertiary amine salts, primary amine salts, and unsaturated fatty alkyl amine salts. Long chain anionic surfactants may include C₁₃-C₁₈ alkyl ether sulphates, C₁₃-C₁₈ acyl lactylates, C₁₃-C₁₆ acyl methyl taurates, C₁₃-C₁₅ acyl isethionates, C₁₃-C₁₆ alkyl sulphates, C₁₃-C₁₆ acyl sarcosinates, C₁₃-C₁₆ alkyl sulphosuccinates, C₁₃-C₁₆ alkyl ether sulphosuccinates, or mixtures thereof.

The amount of hydrophobic liquid loaded onto the adsorbing substrate may be at least 15% by weight, or at least 30% by weight, or at least 40% by weight, or at least 50% by weight or even at least 60% by weight, based on the total weight of the adsorbing substrate. In other embodiments, the amount of hydrophobic liquid loaded onto the adsorbing substrate may be less than 70% by weight, or less than 65% by weight or less than 60% by weight or even less than 50% by weight, based on the total weight of the adsorbing substrate. In still other embodiments, the amount of hydophobic liquid adsorbed onto the substrate may range from between 15%-70% by weight, or between 30%-65% by weight, or between 45%-60% by weight, based on the total weight of the adsorbing substrate.

The hydrophobic liquid may be generally loaded onto the adsorbing substrate by placing the adsorbing substrate in contact with the hydrophobic liquid. For example, the adsorbing substrate may be placed in a mixer or a fluidized-bed and the hydrophobic liquid may then be added to the mixer or fluidized bed to contact the adsorbing substrate. In some cases the use of stirred fixed beds or moving beds is conceivable.

The equipment required for this is known to those skilled in the art. For example the equipment may include heatable apparatuses which are preferably provided with mixing tools, for example agitators. The required energy input can result, for example, from heatable vessel walls, heatable mixing tools and/or mechanical energy input.

In some cases, sufficient mixing is achieved alone as a result of molecular motion and density differences after a sufficiently long time, or via slow stirring or folding. If necessary, intensive agitation can be employed using optimized geometry and high-speed agitating or mixing elements.

In some cases a rotary motion or shaking motion of the complete apparatuses is sufficient in itself. In other cases, the necessary energy input for mixing is achieved via pumping the substances through static mixers, blending, or via other dispersion machinery. The energy input can also be achieved, for example, via ultrasonicating.

Batch or continuous mixers can be used. The adsorbing substrate is introduced with or without other additives. Plowshares, blades, screws or the like ensure product mixing which is intensive to a greater or lesser extent. Classic examples are plowshare mixers, conical screw mixers or similar apparatuses.

Generally, batch mixers are used. In this embodiment, the adsorbing substrate is charged with or without additives. Plowshares, blades, screws or the like ensure product mixing is intensive to a greater or lesser extent. Classic examples are plowshare mixers, conical screw mixers or similar apparatuses. Alternatively, product mixing via agitation of the entire vessel is possible. Examples of this are tumble mixers, drum mixers or the like. Another possibility is the use of pneumatic mixers (see Ullmann's Encyclopedia of Industrial Chemistry, Sixth Edition, Mixing of Solids).

The hydrophobic liquid to be adsorbed is metered/added generally via devices for sprinkling or spraying. Examples of these are lances, sprayheads, single-fluid or multi-fluid nozzles, in rare cases rotating sprinkling or atomization devices. In the simplest case, addition locally as a concentrated jet is also possible. Alternatively, the hydrophobic liquid to adsorbed component can first be placed in a mixer, in order then for the adsorbing substrate to be added.

The hydrophobic liquid to be adsorbed can be added at superatmospheric pressure, atmospheric pressure or reduced pressure compared with atmospheric pressure, preferably at atmospheric pressure and reduced pressure.

In isolated cases, it can be advantageous to preheat the hydrophobic liquid to be adsorbed (to decrease viscosity, change in wetting properties), and also to supply or remove heat via the vessel wall and/or the mixing tools. In isolated cases it can be necessary to remove water vapor or solvent vapor.

To increase the loading of the adsorbing substrate and to minimize oxygen inclusions, it can be expedient to evacuate the mixer containing the adsorbing substrate before feed of the hydrophobic liquid, and also if appropriate, to blanket it with protecting gas. Depending on the adsorbing substrate, this may be repeated several times.

Alternatively, continuous mixers may be used. The hydrophobic liquid to be adsorbed and adsorbing substrate are preferably added in this case at different points in the mixer.

In other embodiments, the hydrophobic liquid may be loaded onto the adsorbing substrate batchwise or continuously in fluidized beds. In this instance, the adsorbing substrate is agitated via a fluidizing gas, which may be hot. Air or inert gas is suitable as fluidizing gas. In isolated cases it is expedient to supply or remove heat via the vessel wall and/or via heat exchanger surfaces immersed in the fluidized bed. Suitable fluidized beds and the peripheral equipment required are part of the prior art. The hydrophobic liquid to be adsorbed is metered and, if appropriate, preheated, batchwise or continuously by means of the above described devices which are known to those skilled in the art. For example, the adsorbing substrate can be charged in a fluidized bed. The substrates are fluidized and the hydrophobic liquid is then applied/loaded by spraying, sprinkling etc. at a desired concentration.

In isolated cases, the hydrophobic liquid loaded adsorbing substrate can advantageously be produced by means of a combination of mixer and fluidized bed.

In some cases it can be advantageous, during the production of liquid loaded adsorbing substrates in a mixer, or immediately thereafter/before, to add agents such as talc, silicates, asphaltite or the like, to avoid agglutination or to increase loading capacity.

In some instances, it is advantageous, by selecting suitable temperatures, to lower the viscosity of the hydrophobic liquid to be adsorbed to the extent that a sufficiently rapid and sufficiently complete loading of the adsorbing substrate can be achieved. The hydrophobic liquid can be heated, for example, in an upstream vessel or heatable piping. The adsorbing substrate can, if necessary, likewise be added preheated. The mixture of hydrophobic liquid and adsorbing substrate can be heated together or separately or else in the mixer itself. The heating can be performed by heat exchange via the vessel wall or heated mixing elements or via the input of mechanical stirring or mixing energy.

The mixture can be cooled again in the mixer itself by heat exchange via the vessel wall or coolable mixing elements or, in rare cases, by utilizing evaporative cooling. Obviously, cooling in downstream apparatuses or, in the simplest case, by heat exchange with the environment during storage is also possible.

In isolated cases, it may be necessary during production to remove water vapor or solvent vapor. This can take place in the mixer itself via associated filters or in downstream apparatuses, for example in further dryers, mixers, stirred tanks, fluidized beds, spray dryers, prilling towers, etc., preferably under reduced pressure or atmospheric pressure.

Internals known in the prior art have been found to be useful, which internals reinforce targeted mixing of the adsorbing substrate to be loaded. Examples of these are rotary displacement bodies, Wurster tubes, or else specially fabricated fluidized-bed gas distribution plate geometries (inclination and/or perforation of the gas-distribution plate) or reinforcing the specific solids motion by means of appropriately arranged nozzles, for example tangential single-fluid nozzles, or two-fluid or multiple-fluid nozzles.

After production, the composition, once produced, may be packaged and then stored for an extended period of time (for e.g., in vapor barrier plastic or paper bags) without remassing or significant agglomeration.

In another aspect, the present disclosure contemplates utilization of the composition, prepared as above-described, in the preparation of an NAF invert emulsion. NAF invert emulsions for drilling applications are prepared by combining the composition of the present disclosure, an oil-based or hydrocarbon continuous phase, and an aqueous dispersed phase (for e.g., water or an aqueous brine solution). Usually, the composition is added first to either the oil phase or an existing emulsion thereby releasing at least a portion of the liquid loaded onto the adsorbing substrate into the oil phase or the aqueous phase, and the aqueous phase is then gradually added to the oil phase with vigorous mixing. In any event, the resulting mixture will generally comprise from about 1% to about 5% by weight of the liquid and from about 5% to about 40% by weight of the aqueous phase, with the balance being the oil phase. The amount of liquid required to produce a stable emulsion in any given application will depend on the relative proportions of the oil and aqueous phases as well as upon the chemical nature of the respective phases and the particular manner in which the emulsion is prepared.

To prepare the emulsion, the mixture of composition, aqueous phase, and oil phase is subjected to high shear conditions to provide the invert emulsion. Any of a wide variety of slow or high speed mixers or agitators, homogenizers, colloid mills, etc. may be used to obtain the degree of contact between the phases, required to disperse the internal aqueous phase in the external oil phase. If desired, the rate of dispersion may be increased by emulsifying at somewhat elevated temperatures.

The liquid loaded adsorbing substrate is compatible with any of a number of oil bases typically used in NAF invert emulsions, including mineral oil, diesel oil and other hydrocarbons, such as C₁₂-C₂₀ paraffins, iso-paraffins, olefins, iso-olefins, aromatics, naphthalenes, and other hydrocarbon mixtures including various products of crude oil refining. For the aqueous phase, a brine solution is often used, with representative brine solutions containing sodium chloride, potassium chloride, magnesium chloride, calcium chloride, or mixtures of these in amounts up to saturation of the aqueous phase. Typical salt concentrations range from about 20% by weight to about 35% by weight of the aqueous phase. Dissolved salts in the aqueous phase can be used, for example, to increase drilling fluid density, decrease swelling effects of aqueous matter on formation clays, and reduce hole enlargement caused by the dissolution of water soluble formation components.

When the emulsion is to contain suspended solids (for e.g., a clay) or other additive(s), these are typically added after the emulsion is prepared under high shear conditions, rather than to one phase or the other. Additives may be introduced simultaneously or sequentially, and accompanied by continuous mixing or agitation. For example, a weighting material which increases the density of the drilling fluid may be added. The weighting agent may be any of the high density materials conventionally employed (for e.g., barites, whiting, calcined clay, etc.) to achieve a desired density (for e.g., 1.05-2 g/ml or 65-125 lbs/ft³). Other solid additives include organoclays to help suspend drill cuttings.

Additives, which serve to increase viscosity and prevent the escape of the fluid into permeable formations traversed by the well bore, may be incorporated into the NAF invert emulsion. The amount added should not increase the viscosity of the composition to such an extent that efficient pumping of the drilling fluid is compromised. Such additives are usually a hydratable clay or clay-like material. Other conventional additives, including filter loss agents, other viscosifiers, wetting agents, stabilizers, gel strength and other rheological control agents, etc. may be incorporated into the invert emulsion drilling fluid.

In still other aspects, there is provided a method for using the NAF invert emulsion in drilling applications. In one embodiment, the NAF invert emulsion with optional additives are mixed/formulated at a rig site and used in the drilling, completion, working over and fracturing of subterranean oil and gas wells by circulating, such as by a pump, the NAF invert emulsion with optional additives through subterranean oil and gas well. Thus, according to one general embodiment, there is provided a method, comprising pumping the NAF invert emulsion into a wellbore; circulating the NAF invert emulsion through a wellbore while drilling; collecting the NAF invert emulsion at the surface; optionally removing at least a portion of the liquid-loaded adsorbing substrate from the NAF invert emulsion; and re-circulating the NAF through the wellbore.

### EXAMPLES

### Example 1. Liquid-Loaded Absorbing Substrate (35-55 wt. % Emulsifier Loaded onto the Adsorbing Substrate)

The following components were combined to form a base fluid formulation and the fluid properties were then determined:

| Fluid Formulation (Actual numbers) | Base |
|---|---|
| Diesel, bbl | 0.598 |
| Organoclay, ppb | 7.5 |
| Lime, ppb | 3 |
| Dry Emulsifier, ppb | 6 |
| Water, bbl | 0.196 |
| 25% CaCl₂ powder, ppb | 24.5 |
| Barite, ppb | 213.7 |
| Fluid loss control additive, ppb | 3.5 |
| API Evaluation Clay, ppb | 35.0 |
| Barite, ppb | 150 |

| Fluid Properties | Base | Aged Base | Clay | Barite |
|---|---|---|---|---|
| Aging Temp, ° F. | 250 | 250 | 250 | 250 |
| Aging Time, hrs | 16 | 16 | 16 | 16 |
| Mud Weight, ppg | 12.0 | | | |
| 600 rpm | 60 | 48 | 60 | 66 |
| 300 rpm | 41 | 28 | 37 | 40 |
| 200 rpm | 32 | 22 | 29 | 30 |
| 100 rpm | 23 | 14 | 20 | 20 |
| 6 rpm | 10 | 4 | 8 | 7 |
| 3 rpm | 9 | 4 | 7 | 6 |
| PV, cps | 19 | 20 | 23 | 26 |
| YP, lbs/100 ft² | 22 | 8 | 14 | 14 |
| 10 Second Gel | 11 | 6 | 9 | 8 |
| 10 Minute Gel | 12 | 6 | 12 | 10 |
| E.S., V | 561 | 378 | 260 | 255 |
| HTHP @ 250° F., | 2.0 | 3.0 | 5.6 | 3.2 |
| ml | | | | |
| Water, ml | — | — | — | — |

### Example 2. Liquid-Loaded Adsorbing Substrate (35-55 wt. % Emulsifier Loaded onto the Adsorbing Substrate)

The following components were combined to form a base fluid formulation and the fluid properties were then determined:

| Fluid Formulation | Base |
|---|---|
| Diesel, bbl | 0.598 |
| Organoclay, ppb | 7.5 |
| Lime, ppb | 3 |
| Dry Emulsifier, ppb | 6 |
| Water, bbl | 0.196 |
| 25% CaCl₂ powder, ppb | 24.5 |
| Barite, ppb | 213.7 |
| Gilsonite, ppb | 5 |
| API Evaluation Clay, ppb | 35.0 |
| Barite, ppb | 150 |

| Fluid Properties | Base | Aged Base | Clay | Barite |
|---|---|---|---|---|
| Aging Temp, ° F. | 250 | 250 | 250 | 250 |
| Aging Time, hrs | 16 | 16 | 16 | 16 |
| Mud Weight, ppg | 12.0 | | | |
| 600 rpm | 90 | 61 | 74 | 90 |
| 300 rpm | 59 | 36 | 45 | 53 |
| 200 rpm | 48 | 24 | 34 | 39 |
| 100 rpm | 35 | 14 | 25 | 25 |
| 6 rpm | 19 | 4 | 9 | 8 |
| 3 rpm | 18 | 3 | 8 | 7 |
| PV, cps | 31 | 25 | 29 | 37 |
| YP, lbs/100 ft² | 28 | 11 | 16 | 16 |
| 10 Second Gel | 27 | 6 | 11 | 10 |
| 10 Minute Gel | 56 | 10 | 17 | 14 |
| E.S., V | 788 | 565 | 402 | 292 |
| HTHP @ 250° F., | 1.4 | 5.0 | 7.6 | 1.6 |
| ml | | | | |

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

1. A composition for use in drilling fluids comprising a substrate loaded with an amount of a hydrophobic liquid, wherein the hydrophobic liquid comprises an emulsifier, and the amount of hydrophobic liquid loaded onto the substrate is at least 15% by weight, based on the total weight of the substrate, and the substrate has a surface area of greater than 100 m²/g.

2. The composition of claim 1, wherein the amount of hydrophobic liquid is between 30-65% by weight, based on the total weight of the substrate.

3. The composition of claim 1, wherein the amount of hydrophobic liquid is between 45-60% by weight, based on the total weight of the substrate.

4. A composition for use in drilling fluids comprising a substrate loaded with a hydrophobic liquid, wherein the hydrophobic liquid comprises a tall oil fatty acid, an imidazoline, a polyamide, a carboxylic acid fatty amine condensate or a mixture thereof.

5. The composition of claim 4, wherein the substrate has a surface area of greater than 100 m²/g.

6. The composition of claim 4, wherein the substrate comprises an inorganic substrate, an organic substrate, or a mixture thereof.

7. The composition of claim 6, wherein the inorganic substrate is a silicate, an aluminosilicate, perlite, diatomaceous earth, a metal oxide or a mixture thereof.

8. The composition of claim 6, wherein the organic substrate is a fibrous cellulose component, an asphalt-type hydrocarbon, carbon black, activated carbon, or a mixture thereof.

9. The composition of claim 4, wherein the hydrophobic liquid is tall oil fatty acid.

10. The composition of claim 9, wherein the tall oil fatty acid is modified tall oil fatty acid or oxidized tall oil fatty acid.

11. The composition of claim 4, wherein the hydrophobic liquid is an imidazoline or a modified imidazoline.

12. The composition of claim 4, wherein the hydrophobic liquid is a polyamide formed from the reaction of a diamine with a fatty acid ester, fatty acid, or combinations thereof.

13. The composition of claim 4, wherein the hydrophobic liquid is selected from the group consisting of a rheology modifier, a viscosifier, a quaternary amine and a mixture thereof.

14. The composition of claim 4, wherein the hydrophobic liquid further comprises a long chain cationic surfactant or a long chain anionic surfactant.

15. A method for producing a substrate loaded with a hydrophobic liquid comprising the steps of: loading the hydrophobic liquid onto a substrate; and placing the substrate in contact with the hydrophobic liquid, wherein the hydrophobic liquid comprises a tall oil fatty acid, an imidazoline, a polyamide, a carboxylic acid fatty amine condensate, or a mixture thereof.

16. The method of claim 15, wherein the substrate and the hydrophobic liquid are contacted in a batch mixer or fluidized bed.

17. A non-aqueous phase invert emulsion obtained by combining, under high shear, a composition comprising a substrate loaded with a hydrophobic liquid with an oil-based or hydrocarbon continuous phase, and an aqueous dispersed phase, wherein the hydrophobic liquid comprises a tall oil fatty acid, an imidazoline, a polyamide, a carboxylic acid fatty amine condensate or a mixture thereof.

18. The non-aqueous phase invert emulsion of claim 17, wherein the continuous phase comprises mineral oil, diesel oil, a C₁₂-C₂₀ paraffin, an iso-paraffin, an olefin, an iso-olefin, an aromatic, a naphthalene, or a mixture thereof.

19. The non-aqueous phase invert emulsion of claim 17, wherein the aqueous dispersed phase comprises a brine solution containing sodium chloride, potassium chloride, magnesium chloride, calcium chloride, or a mixture thereof.

20. (canceled)
